(19) United States
(12) Patent Application Publication
(10) Pub. No.: US 2016/0263980 A1
(43) Pub. Date: Sep. 15, 2016

(54) HYBRID ELECTRICAL POWER SYSTEM FOR INDUSTRIAL ELECTRIC VEHICLE

(71) Applicant: M-field Energy LTD., Taipei City (TW)

(72) Inventors: CHAO-LIANG PENG, Taipei (TW); CHE-PING CHOU, Taipei (TW); CHEN-SHENG LIN, Taipei (TW); CHIH-PIN HSU, Taipei (TW)

(21) Appl. No.: 14/641,666

(22) Filed: Mar. 9, 2015

(51) Int. Cl. B60K 1/04; H01M 16/00; H01M 2/10; H01M 8/04; H01M 8/02; H01M 8/10; B60L 11/18; H01M 10/0525

(52) U.S. Cl. CPC B60K 1/04; B60L 11/1877; B60L 11/1896; H01M 16/006; H01M 10/0525; H01M 8/04201; H01M 8/0273; H01M 8/04089; H01M 8/1004; H01M 2/1083; B60L 2200/42; H01M 2220/20; H01M 2250/20

(57) ABSTRACT

A hybrid electrical power system for an industrial electric vehicle such as an electric forklift, includes a base weight, an electrical power module on the base weight and front and rear frame supports erected from the base weight and sandwiching the electrical power module therebetween. The electrical power module includes a fuel cell module having a fuel cell stack, a hydrogen storage tank and an air blower, and a Li-ion rechargeable battery module. A weight of the base weight is about 70%-80% of a total weight of the system. A weight of a fixer for the hydrogen storage tank is about 10% of the total weight of the system. The blower is connected to a filter via a resonator to reduce a noise level generated by air blower. Electrode plates and membranes of the fuel cell stack are vertically stacked up.

### CROSS-REFERENCE TO RELATED APPLICATIONS

This application is related to co-pending application Ser. No. ______, entitled “HYBRID ELECTRICAL POWER SYSTEM FOR INDUSTRIAL ELECTRIC VEHICLE AND METHOD OF OPERATION THEREOF” and having an attorney docket number “US57958”, and co-pending application Ser. No. ______, entitled “FUEL CELL SYSTEM FOR INDUSTRIAL ELECTRIC VEHICLE” and having an attorney docket number “US57959.” The two co-pending applications are assigned to the same assignee as the present application and have the same filing date as the present application. The disclosures of the two co-pending applications are incorporated herein by reference.

### FIELD

The present disclosure relates to a hybrid electrical power system for use in a vehicle, and particularly to a hybrid electrical power system for use in an industrial electric vehicle such as a forklift.

### BACKGROUND

The currently commercial industrial electric vehicle, such as an electric forklift is powered by lead-acid batteries. The disadvantage of the lead-acid battery is that it has a limited operation time and needs a long recharging period. The lead-acid battery can only be charged at 0.2 C (charge rate), which means that once the battery is depleted, it will take 6-8 hours to recharge to its fully charged state. Accordingly, in a warehouse which has a non-stop operation, it usually needs to prepare two or three additional sets of battery for one electric forklift.

To overcome the disadvantage of the lead-acid battery, Li-ion batteries are introduced, which have the advantage of high charge rate of 1 C. Such advantage greatly reduces the lengthy recharge time. However, the Li-ion battery cannot afford stable power density during the period of its output. The voltage drops quickly after 40% SOC (state of charge). This results in a slower movement of the electric forklift. The slow movement or the one-hour charging time of the forklift powered by Li-ion battery may be acceptable for a small warehouse. However for a large warehouse, speed and equipment utilization rate are important. Accordingly, a hybrid electrical power system incorporating a Li-ion battery and a fuel cell module is developed.

Both the Li-ion battery and the fuel cell module are much lighter than the traditional lead-acid battery. When the hybrid electrical power system is used in a forklift to replace the traditional lead-acid battery thereof, a weight distribution of the of the hybrid electrical power system must be considered to enable the forklift to maintain its balance when it works to transport goods.

Furthermore, in operation, an air blower which is used to draw air into a fuel cell stack of the fuel cell module can generate a high level of noise which may cause disturbing annoyance to the operator of the forklift; such an annoying noise is unfavorable in view of the health of the operator and safety of the operation of the vehicle.

Finally, the electric forklift is operated in a shock and vibration condition. Such shock and vibration may cause displacement of electrode plates of the fuel cell stack and accordingly, result in a low efficiency in generating electricity or even a malfunction of the fuel cell module.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a hybrid electrical power system in accordance with the present disclosure

FIG. 2 is an exploded view of the hybrid electrical power system of FIG. 1.

FIG. 3 is an exploded view of an electrical power module of the hybrid electrical power system of FIG. 1.

FIG. 4 is a view similar to FIG. 1, with some parts thereof being removed to show an inner structure of the hybrid electrical power system.

FIG. 5 is an explode view of FIG. 4 from a different aspect.

FIG. 6 is a view similar to FIG. 4 with some further parts thereof being remove to show a further inner structure of the hybrid electrical power system.

FIG. 7 is a view similar to FIG. 6, viewed from a different angle.

FIG. 8 is a front, diagrammatic view of a part of a fuel cell stack of the hybrid electrical power system of FIG. 7.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a hybrid electrical power system for use in a vehicle, particularly an industrial electric vehicle such as an electric forklift.

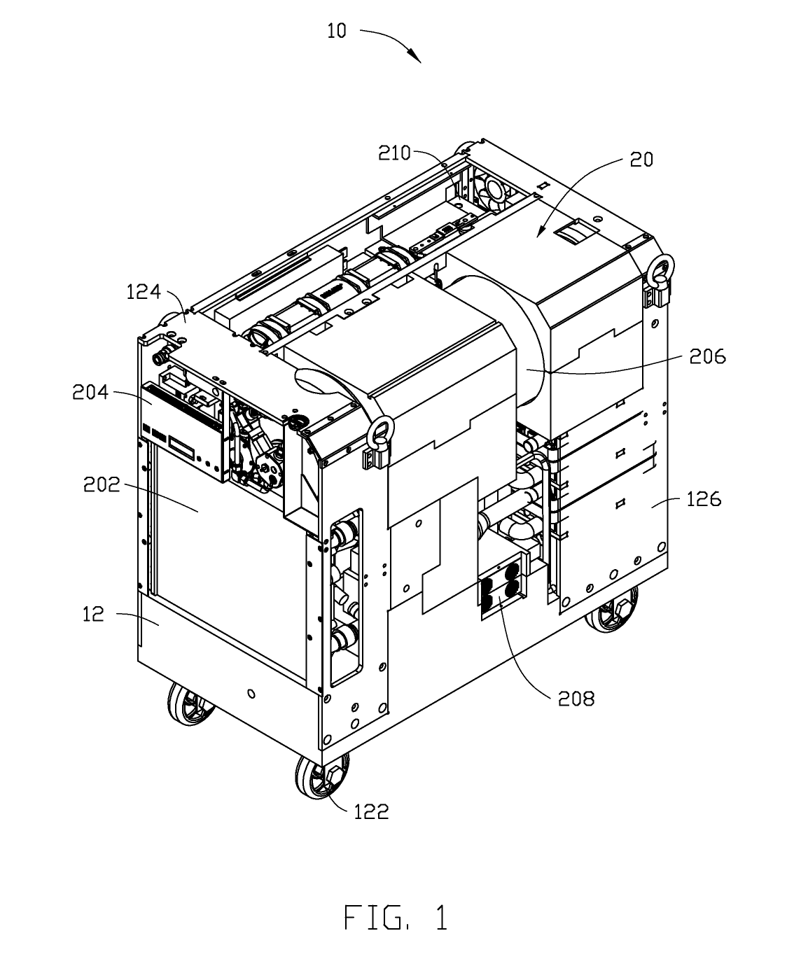

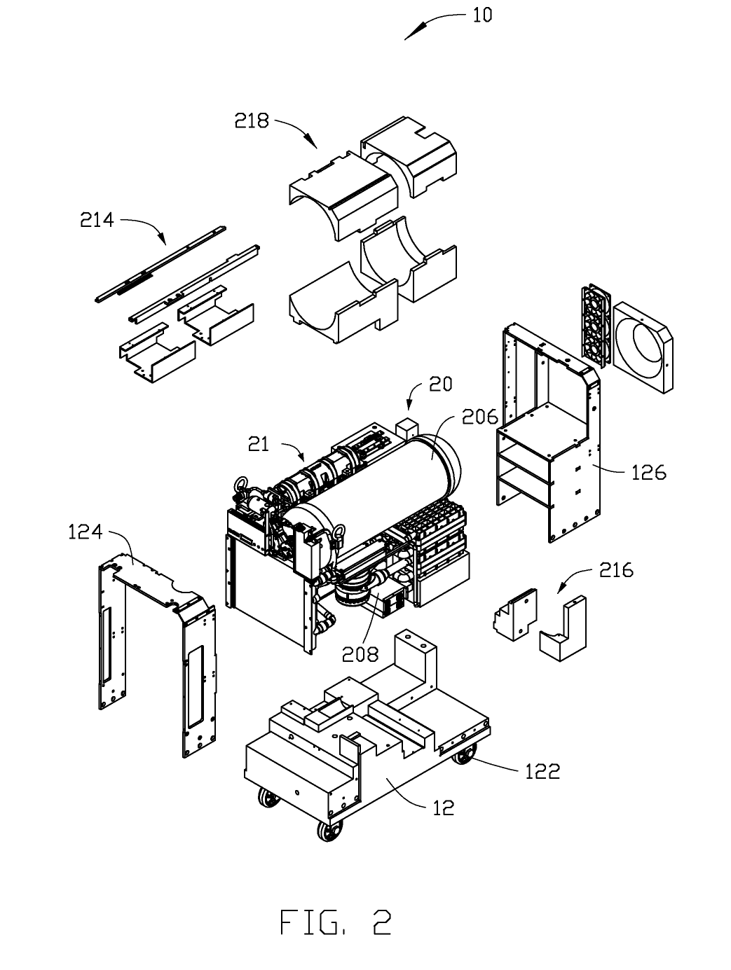

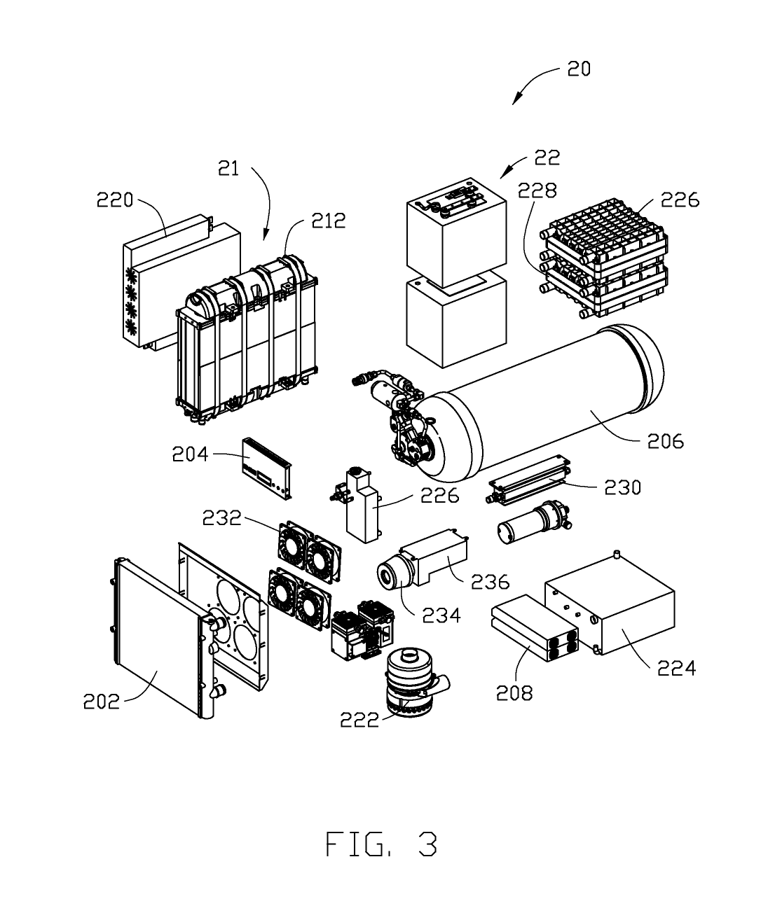

FIG. 1 illustrates an isomeric view of a hybrid electrical power system 10 for use in a vehicle (not shown) which can be an industrial electric vehicle such as a forklift. Also referring to FIG. 2, the system 10 includes a base weight 12 for supporting the system 10. The base weight 12 is attached with four wheels 122 at a bottom side thereof, thereby to facilitate mobility the system 10. A first frame support 124 is vertically mounted on a first end (i.e. front end) of the base weight 12 and a second frame support 126 is vertically mounted on an opposite second end (i.e., rear end) of the base weight 12. The first and second frame supports 124, 126 and the base weight 12 cooperatively define a space thereamong for receiving components of an electrical power module 20 of the system 10 therein. The electrical power module 20 includes a fuel cell module 21 and a Li-ion battery module 22 (better seen in FIG. 3). The fuel cell module 21 includes a cooling radiator 202 and a controller 204 located in the first frame support 124. A hydrogen storage tank 206 extends between top corners the first and second frame supports 124, 126. An auxiliary power supply 208 is located below the hydrogen storage tank 206. A power output 210 of the electrical power module 20 of the system 10 is located near the second frame support 126.

Also referring to FIG. 3, the fuel cell module 21 of the electrical power module 20 of the hybrid electrical power system 10 also includes a fuel cell stack 212. A first support 214 is used for supporting the Li-ion battery module 22. A second support 216 is provided for supporting the auxiliary power supply 208. A fixer 218 is for fixing the hydrogen storage tank 206 in position.

Particularly referring to FIG. 3, the fuel cell module 21 of the electrical power module 20 further comprises a DC/DC (direct current/direct current) converter 220 for converting a voltage of direct current generated by the fuel cell stack 212 to a required voltage. The Li-ion battery module 22 is in electrical connection with the fuel cell stack 212 to output required electrical power to a load of the vehicle, which usually is an electric motor. The controller 204 controls the output of the fuel cell stack 212 and the Li-ion battery module 22 in accordance with the condition of the load to provide an optimal power output combination. An air blower 222 is used for drawing air into the fuel cell stack 212 whereby in the fuel cell stack 212 oxygen in the air can have a chemical reaction with hydrogen from the hydrogen storage tank 206. An auxiliary water collector 224 is used for collecting water drain from the air. A water tank 226 is used for collecting therein cooling water and water drain from the hydrogen. Two humidifiers 226, 228 are used for humidifying the air and the hydrogen before they flow into the fuel cell stack 212. A heat exchanger 230 is used for exchanging heat between the cooling water and the hydrogen whereby the hydrogen can be heated before it flows into the fuel cell stack 212. The cooling radiator 202 is used for releasing heat in the cooling water when the cooling water flows through the cooling radiator 202 after it leaves the fuel cell stack 212. A plurality of cooling fans 232 is used for generating an air flow through the cooling radiator 202 to facilitate release of heat from the cooling water by the cooling radiator 202. The air blower 222 draws the air heated by the cooling radiator 202 into the fuel cell stack 212 via a filter 234 and a resonator 236 to have the chemical reaction with the hydrogen.

According to the present disclosure, to enable the vehicle to work normally, particularly when the vehicle is an electric forklift that can stably lift and move heavy goods without losing its balance to incline forwardly, the base weight 12 of the hybrid electrical power system 10 is designed to have a weight which is about 70%-80% of a total weight of the hybrid electrical power system 10, wherein the hybrid electrical power system 10 has a weight of about 800 kg. To achieve this, the base weight 12 is formed by cast iron or lead or a metal having a density no less than 6800 kg/m³, whereby a gravity of the hybrid electrical power system 10 can be as low as possible and operation of the forklift can be performed smoothly. A top of the base weight 12 is cast or machined to have a shape corresponding to a shape of a bottom of the electrical power module 20 whereby the electrical power module 20 can be fitted over the base weight 12. The first and second supports 214, 216 and the first and second frame supports 124, 126 and the fixer 218 add weight to the hybrid electrical power system 10 to enable the hybrid electrical power system 10 to have a weight reaching the weight of the conventional lead-acid battery, wherein the first and second supports 214, 216 and the first and second frame supports 124, 126 weight about 10% of the total weight of the hybrid electrical power system 10. The fixer 218 also weights about 10% of the total weight of the hybrid electrical power system 10. The components of the electrical power module 20 as shown in FIG. 3 weights about 10% of the totally weight of the hybrid electrical power system 10, too.

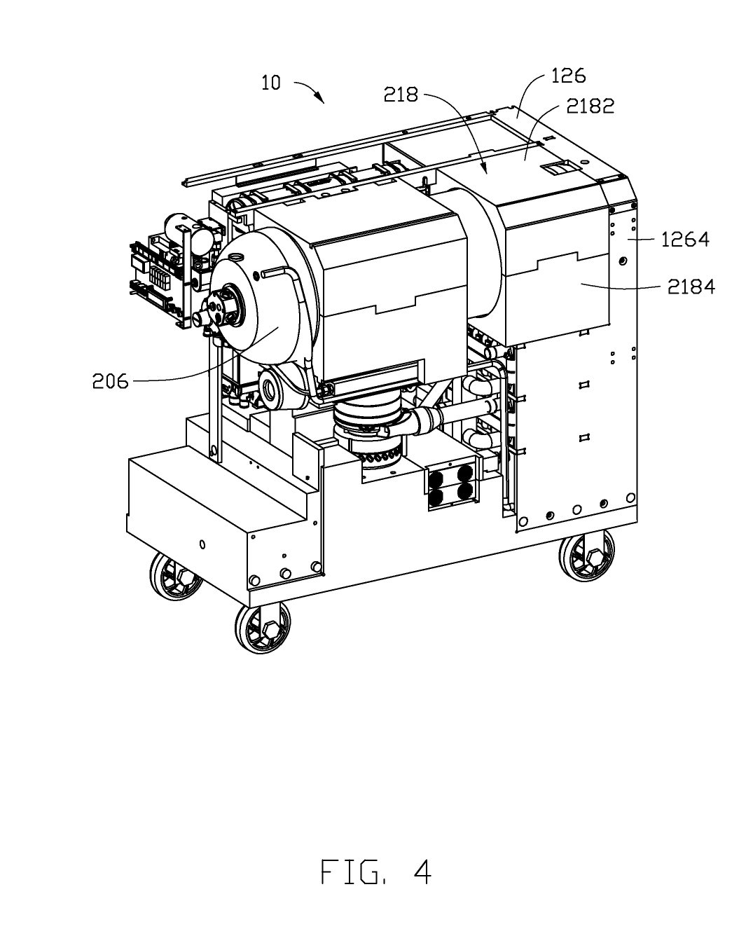

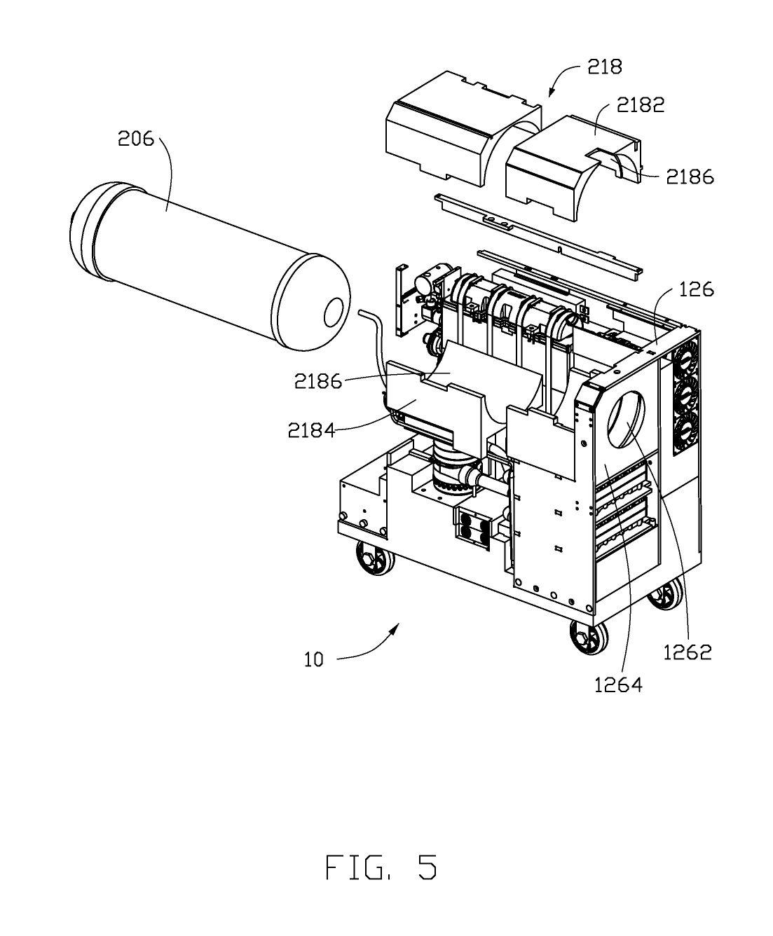

Referring to FIGS. 4 and 5, the fixer 218 consists two upper clamping blocks 2182 and two lower clamping blocks 2184 each having an arced interior 2186 (best seen in FIG. 5) for conformably engaging an exterior of hydrogen storage tank 206 to fix the hydrogen storage tank 206 in position. The hydrogen storage tank 206 is mounted to the fixer 218 by inserting the hydrogen storage tank 206 into a space defined over the lower clamping blocks 2184 until a rear end of the fuel storage tank 206 engages in a hole 1262 (best seen in FIG. 5) defined by a stop 1264 of the second frame support 126. Then the upper clamping blocks 2182 are brought to fittingly engage tops of the lower clamping blocks 2184 to have the hydrogen storage tank 206 clamped therebetween. The design of the two upper clamping blocks 2182 and two lower clamping blocks 2184 of the fixer 218 can facilitate the assembly of the hydrogen storage tank 206 to the fixer 218 even when there is a small deviation between a central line of fuel storage tank 206 and a central line of the fixer 218.

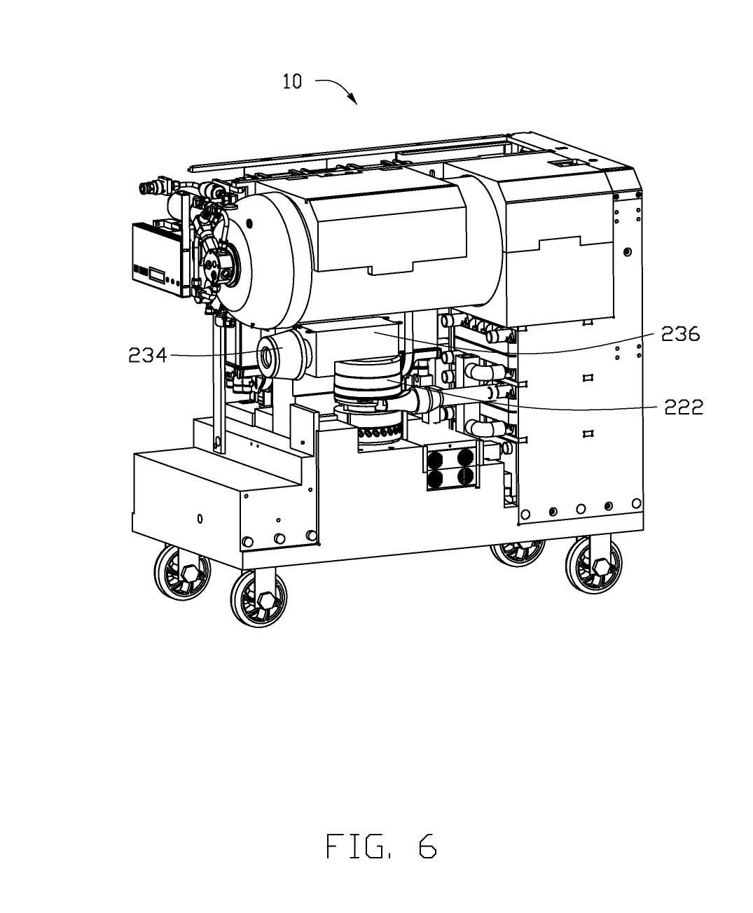

Referring to FIG. 6 in corporation with FIG. 3, the filter 234 is functioned as an inlet of the air drawn by the air blower 222 into the fuel cell stack 212. Although not shown in FIG. 6, the filter 234 is mounted behind the cooling radiator 202. The resonator 236 interconnects the filter 234 and the air blower 222, whereby when the air blower 222 is operated, the air is drawn thereby to flow through the cooling radiator 202, the filter 234, the resonator 236 and the air blower 222 to reach the fuel cell stack 212 via a pipeline (shown in FIG. 3, not labeled) coupling the air blower 222 and the fuel cell stack 212. The filter 234 has a configuration of a frustum, and the resonator 236 has a configuration of a rectangular cuboid. The provision of the resonator 236 can reduce the level of noise produced by the air blower 222 when the air blower 222 is operated to draw the air into the fuel cell stack 212. The effect is achieved since when the air blower 222 is operated, the noise generated thereby is transmitted into the resonator 236, in which the noise waves collide each other to cancel out each other, thereby to reduce the level of the noise. A cross-sectional area of the resonator 236 should not be smaller than a cross-sectional area of the air blower 222 to prevent that because of the provision of the resonator 236, a flow rate of the air into the fuel cell stack 212 is lowered.

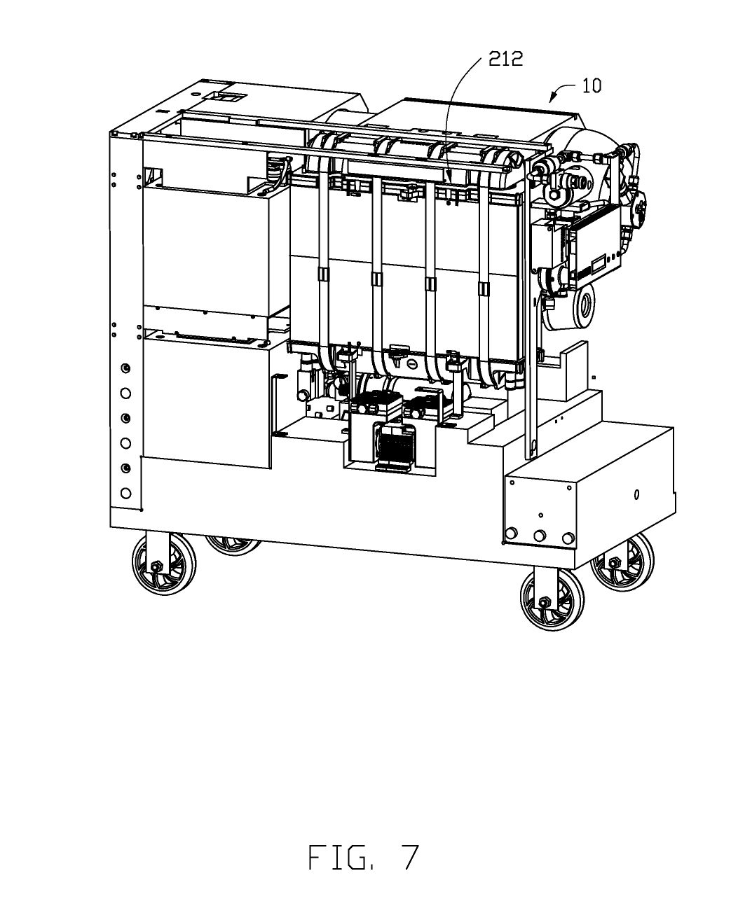

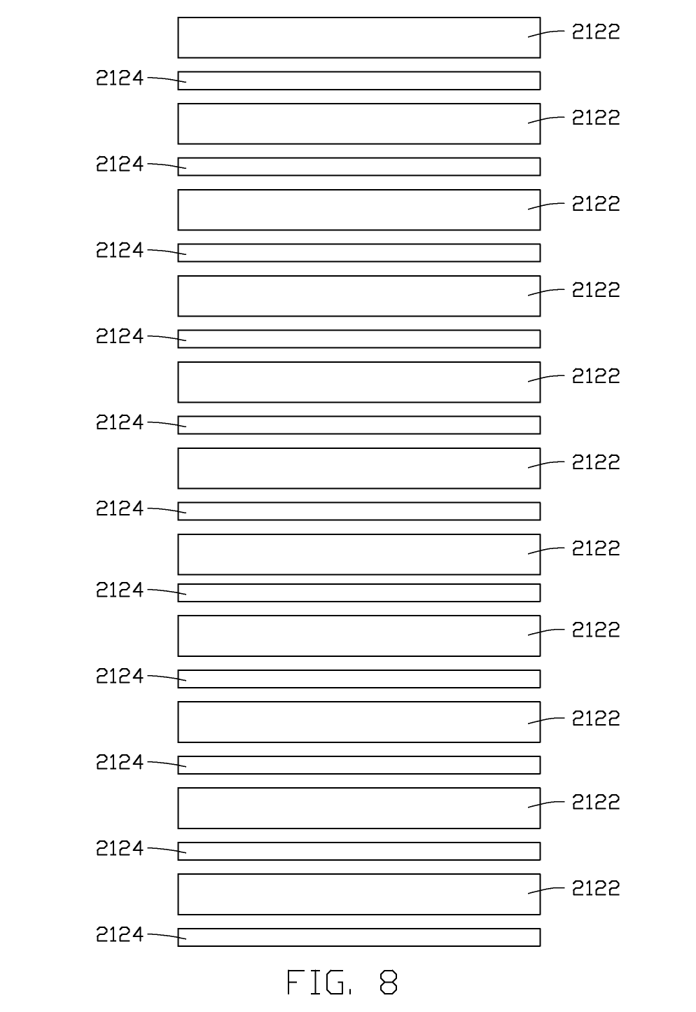

Referring to FIG. 7, the fuel cell stack 212 is mounted substantially at a middle of the system 10. Referring to FIG. 8, the fuel cell stack 212 includes a plurality of alternated electrode plates 2122 and membranes 2124. The electrode plates 2122 and the membranes 2124 are vertically stacked up. By such arrangement, the fuel cell stack 212 can absorb vibration and shock to the hybrid electrical power system 10 which are usually vertically oriented, without causing the electrode plates 2122 to move apart from each other. For a horizontally stacked fuel cell stack, when subjected to the vertical vibration and shock, can cause the electrode plates to slide upwardly and downwardly, which after a period of time can cause the electrode plates to zigzag whereby the fuel cell stack can no longer generate the electricity as originally intended. The vertical stacking of the electrode plates 2122 and the membranes 2124 of the fuel cell stack 212 in accordance with the present disclosure can prevent the distortion of the fuel cell stack 212 even after a long period of use of the fuel cell stack 212 to thereby enable the fuel cell stack 212 to have an extended period of life.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A hybrid electrical power system for a vehicle comprising:
a base weight made of metal; and
an electrical power module consisting of a fuel cell module and a rechargeable battery module, said electrical power module being mounted on the base weight, wherein the base weight has a weight which is about 70%-80% of a total weight of the hybrid electrical power system.

2. The hybrid electrical power system of claim 1, wherein the rechargeable battery module is a Li-ion battery module and the fuel cell module includes a hydrogen storage tank and a fixer for fixing the fuel tank in position, the fixer having a weight which is about 10% of the total weight of the hybrid electrical power system.

3. The hybrid electrical power system of claim 2, further comprising a first frame support erected from a first end of the base weight and a second frame support erected from an opposite second end of the base weight, wherein the fuel cell module and the Li-ion battery module are located between the first and second frame supports.

4. The hybrid electrical power system of claim 3, further comprising a first support and a second support, and the electrical power module further comprising an auxiliary power supply, the first support supporting the Li-ion battery module and the second support supporting the auxiliary power supply.

5. The hybrid electrical power system of claim 4, wherein the first and second frame supports and the first and second supports in combination have a weight which is about 10% of the total weight of the hybrid electrical power system.

6. The hybrid electrical power system of claim 5, wherein the electrical power module weights about 10% of the total weight of the hybrid electrical power system.

7. The hybrid electrical power system of claim 2, wherein the hydrogen storage tank has a substantially cylindrical configuration, the fixer comprising two upper clamping blocks and two lower clamping blocks, the hydrogen storage being fittingly sandwiched between the upper clamping blocks and the lower clamping blocks.

8. The hybrid electrical power system of claim 2, wherein the fuel cell module includes a fuel cell stack, a filter, a resonator and an air blower, the air blower being for drawing air into the fuel cell stack from the filter via the resonator and then the air blower, the resonator being configured for lowering noise generated by the air blower when it is operated to draw air into the fuel cell stack.

9. The hybrid electrical power system of claim 8, wherein a cross-sectional area of the resonator is larger than a cross-sectional area of the air blower.

10. The hybrid electrical power system of claim 9, wherein the resonator has a shape of a rectangular cuboid.

11. The hybrid electrical power system of claim 2, wherein the fuel cell module has a fuel cell stack comprising a plurality of alternated electrode plates and membranes, the electrode plates and the membranes are vertically stacked up.

12. The hybrid electrical power system of claim 2, wherein the base weight is attached with wheels at a bottom side of the base weight.

13. A hybrid electrical power system for an electric forklift comprising:
a base weight;
a front frame support erected from a front end of the base weight;
a rear frame support erected from a rear end of the base weight; and
an electrical power module mounted on the base weight and between the front and rear frame supports;
wherein the electrical power module includes a fuel cell module and a Li-ion battery module, the fuel cell module including a fuel cell stack, an air blower, a hydrogen storage tank, and a fixer for fixing the hydrogen storage tank in position; and
wherein the air blower is coupled to an air inlet via a resonator to reduce a noise level generated by the air blower when it is operated to draw air into the fuel cell stack, the resonator having a cross-sectional area which is lamer than a cross-sectional area of the air blower.

14. The hybrid electrical power system of claim 13, wherein the resonator has a shape of a rectangular cuboid.

15. The hybrid electrical power system of claim 14, wherein the fuel cell stack comprises a plurality of alternated electrode plates and membranes which are vertically stacked up.

16. The hybrid electrical power system of claim 15, wherein a weight of the base weight is about 70%-80% of a total weight of the hybrid electrical power system.

17. The hybrid electrical power system of claim 16, wherein a weight of the fixer is about 10% of the total weight of the hybrid electrical power system.

18. The hybrid electrical power system of claim 17, wherein the hydrogen storage tank is substantially a round cylinder, the fixer comprises two upper clamping blocks and lower clamping blocks each having an arced interior fittingly engaging the hydrogen storage tank, a rear end of the hydrogen storage tank being received in a hole defined in the rear frame support.

19. A hybrid electrical power system for an electric forklift comprising:
a base weight; and
an electrical power module mounted on the base weight and comprising a fuel cell module and a rechargeable battery module in electrical connection with the fuel cell module, the fuel cell module comprising a fuel cell stack, an air blower for supplying air to the fuel cell stack and a hydrogen storage tank for supplying hydrogen to the fuel cell stack;
wherein the base weight is made of metal and has a weight which is about 70%-80% of a total weight of the hybrid electrical power system; and
wherein the fuel cell stack has electrode plates and membranes which are vertically stacked up.

20. The hybrid electrical power system of claim 19, wherein the fuel cell module further comprises a filter and a resonator, the resonator interconnecting the blower and the filter, the resonator being configured for lowering noise level generated by an operation of the air blower in drawing air into the fuel cell stack.

21. A hybrid electrical power system for an industrial electric vehicle, the industrial electric vehicle comprising:
a chassis;
a base weight mounted to a bottom of the chassis; and
an electric power module mounted on the base weight, the electric power module having a fuel cell and a rechargeable battery module;
wherein, the base weight is positioned on the chassis to add stability to the vehicle when used to lift and transport cargo; and
wherein, the base weight weighs 70% to 80% of the weight of the base weight plus the weight of the electric power module.
